(19) United States
(12) Patent Application Publication
(10) Pub. No.: US 2022/0406144 A1
(43) Pub. Date: Dec. 22, 2022

(54) Fitness Challenge and Wagering System and Method

(71) Applicant: Michael Smith, Valparaiso, IN (US)

(72) Inventor: Michael Smith, Valparaiso, IN (US)

(21) Appl. No.: 17/353,914

(22) Filed: Jun. 22, 2021

(51) Int. Cl. G07F 17/32; G06K 9/00

(52) U.S. Cl. CPC G07F 17/3288; G07F 17/323; G06K 9/00335; G16H 40/67

(57) ABSTRACT

A system for completing and wagering on a physical challenge includes an application executable by a computing device includes receiving an activity challenge. The app generates activity data showing a user completing the challenge using the camera associated with the application. The activity data includes time associated with completion or by keeping an elapsed time. The user may also input wager data of the user betting on his own ability to complete the challenge or on completing the challenge in a shorter elapsed time than any other user also completing the same challenge. The activity data, including the time data, and the wager data may be submitted to the third-party entity for determination of completion and which user completed the challenge in the shortest time, the third-party entity transmitting an award notification indicative of a reward amount increased by an amount equal to the winning user's associated wager amount.

### BACKGROUND OF THE INVENTION

This invention relates generally to computer implemented methods for issuing physical challenges and assigning associated rewards for completion or winning and, more particularly, to a computer-implemented system and method for assigning a physical challenge to a user who is then capable of wagering or betting on his own ability to complete the challenge or to finish faster than other competitors.

Various devices, methods, and mobile applications have been proposed that enable users to issue physical activity goals and challenges and rewards to one another so that users of the system can improve their overall health and reach physical activity goals. Other applications exist that enable users to wager on the ability of other people, such as professional athletes, to be victorious in completing physical challenges such as regarding sporting events. For example, it is common for users to bet on which horse will win a race, which athletic team will win a contest, or even which individual athletes will perform the best when compared to other athletes playing a similar position. Although presumably effective for their intended purposes, there is still a need for a system and method that enables users, via a software application, to wager/bet on their own ability to complete a predetermined physical challenge faster than a competitor who is attempting to complete the same physical activity challenge.

Therefore, it would be desirable to have a computer implemented system for completing and wagering on a physical challenge that includes a mobile application executable by an electronic device such as a smart phone.

### SUMMARY OF THE INVENTION

A computer implemented system for completing and wagering on a physical challenge includes a mobile application executable by an electronic device such as a smart phone that performs the steps of a user receiving a physical activity challenge from the application code itself or from a remote third-party party entity (i.e., from the app administrator). The app is configured to generate activity data showing the user completing the received physical activity challenge, such as the taking of still photos or a video recording using the camera of the same cell phone that is running the software application. The generated activity data may include time data indicative of completion of the received physical activity challenge within an associated amount of time or by keeping and generating an elapsed time calculation. Further, the user may input wager data indicative of the user betting on his own ability to complete the received physical activity challenge or, in an embodiment, on completing the challenge in a shorter elapsed time than any other user also completing the same challenge. The generated activity data, including the time data, and the wager data may be submitted to the third-party entity for a final determination of completion and which user completed the challenge in the shortest elapsed time, the third-party entity transmitting an award notification indicative of a predetermined reward amount increased by an amount equal to the winning user's associated wager amount.

Therefore, a general object of this invention is to provide a computer implemented system and method for completing and wagering on a user's own ability to complete the physical activity challenge him within a predetermined amount of time or, in an embodiment, faster than any other user of the software app having received the same challenge in real time.

Another object of this invention is to provide a system and method, as aforesaid, that enables a single user to compete with himself by completing a predetermined challenge within a predetermined time or having a plurality of registrants competing against each other, each registrant having the opportunity to wager on his own ability to complete the challenge and in the shortest amount of time.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a diagrammatic view illustrating a computer implemented system for completing and wagering on a physical challenge according to s preferred embodiment of the present invention;

FIG. 2 is a diagrammatic block diagram illustrating the electronic components of a mobile computing device of a type configured to run the mobile application according to the present invention;

FIG. 3 is a perspective view of a mobile computing device illustrated in a mode of the mobile app recording completion of a physical activity challenge according to the present invention;

FIG. 4 is a flowchart illustrating a process carried out by programming code of the mobile app according to the present invention;

FIG. 5 is a flowchart illustrating a process carried out by programming code associated with an app administrator according to the present invention; and

.FIG. 6 is a schematic view illustrating a hypothetical physical challenge.

### DESCRIPTION OF THE PREFERRED EMBODIMENT

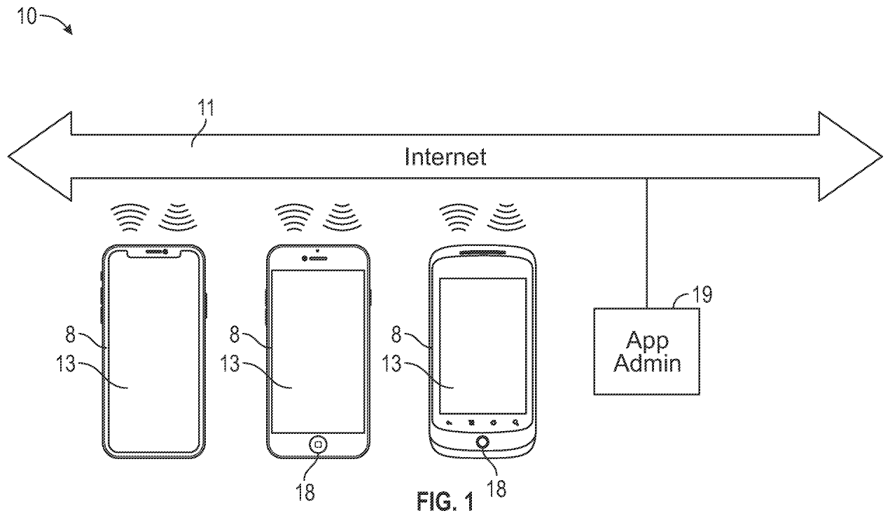

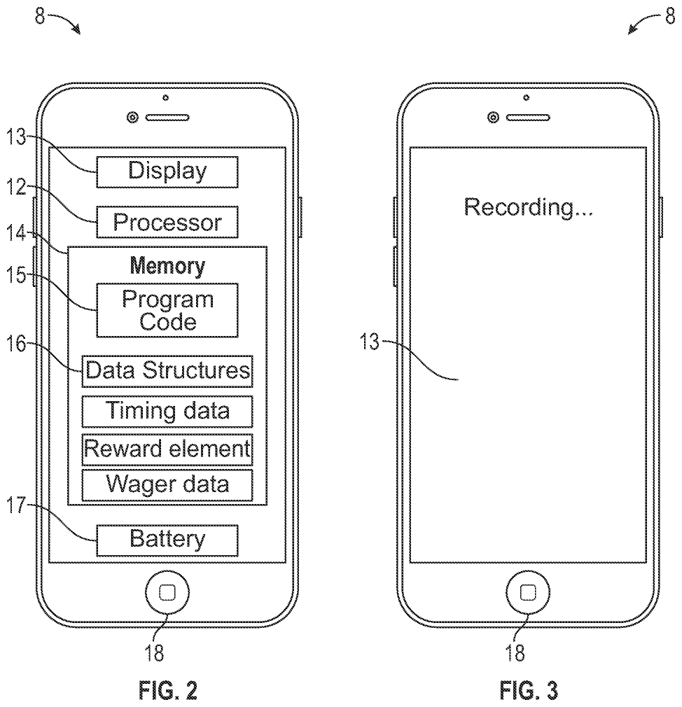

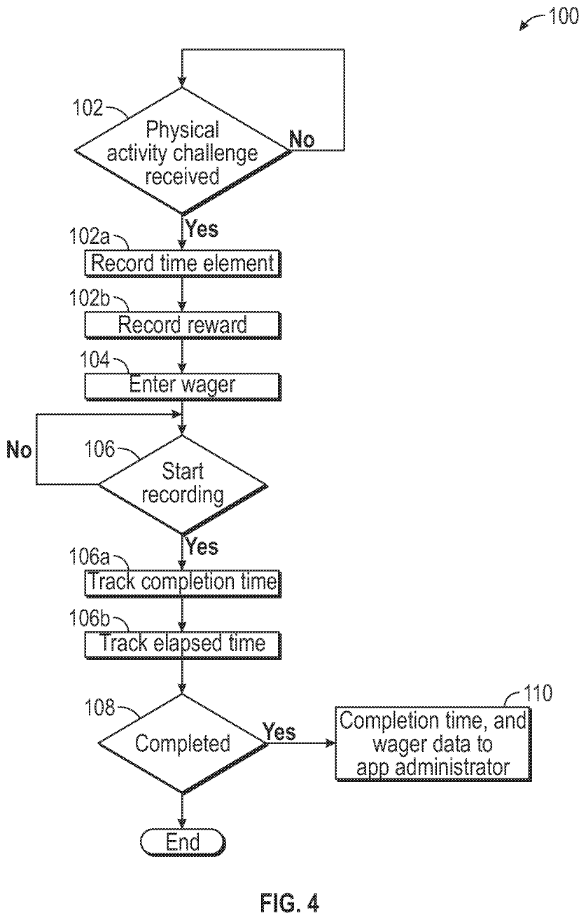

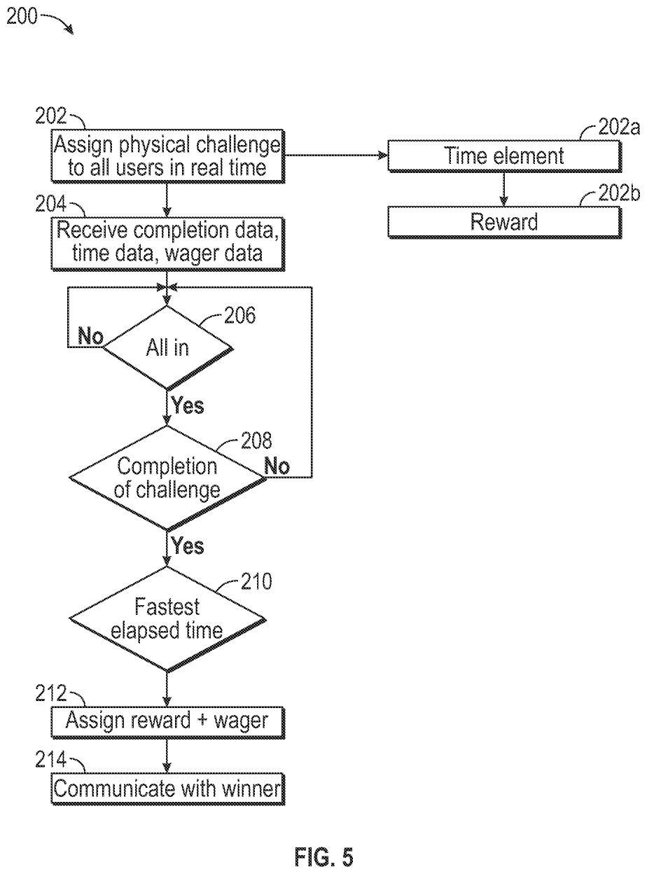

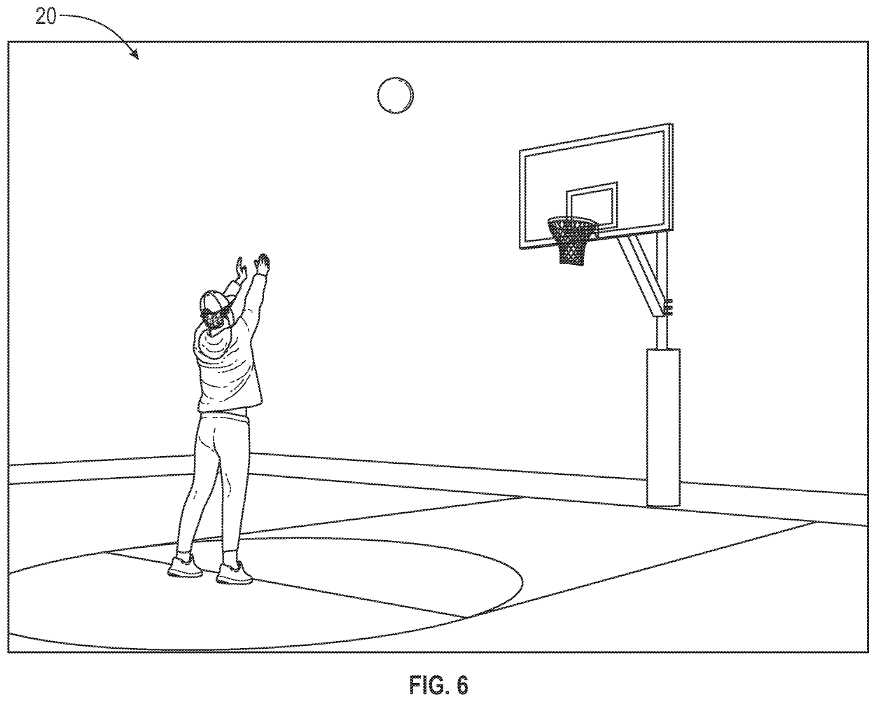

A computer implemented system for completing and wagering on a physical challenge according to a preferred embodiment of the present invention will now be described with reference to FIGS. 1 to 6 of the accompanying drawings. The system 10 may include a processor 12 and a plurality of program instructions referred to as “program code” stored in a non-transitory memory 14 and executable by the processor 12 so as to carry out the steps of the software application 6. Uniquely, the human user of the software app may, using the app, wager/bet on his own ability to complete the physical activity challenge and, in an embodiment, to complete the challenge faster than any other user attempting to complete the identical challenge and under the same conditions.

First, mobile applications are specialized computer software configured for installation and operation on electronic devices and, more particularly, on mobile computing devices 8 such as smart phones, electronic tablets, laptop computers, and the like. Of course, software for desktop computers, workstations, and other personal electronics may also be referred to as application software. At an operational level, a software application (which may also be referred to, in short, as an “app”) may include a plurality of program instructions, also referred to as program code 15, stored in a non-transitory memory 14 that is executable by a processor 12 so as to carry out the method steps of the application 6. Preferably, the processor 12 and non-transitory memory 14 are included or positioned in the case of the mobile computing device 8. The non-transitory memory 14 may include a plurality of data structures 16 for saving the program code 15 as well as for saving the many elements of data that will be described later. It is understood that the app 6 with its plurality of programming instructions may be downloaded through a wide area network such as the Internet 11 by operation of the mobile computing device 8. Accordingly, the program code may then be selectively carried out and executed by the processor 12 of the mobile computing device 8, with all electronic components being powered by the battery 17 of the mobile computing device 8. In some cases, of course, mobile apps may be preinstalled on the mobile computing device 8, making downloads unnecessary and updates may even be automatic. As will be further described later, a mobile app 6 may communicate with third-party websites via the Internet 11 in seamless communications such that transmitters, receivers, and phone numbers are completely unnecessary although such communications are possible in some embodiments. In addition, most mobile computing devices include an electronic display 13 on which status reports, data, alerts, warning messages, advertisements, and the like may be published or displayed and viewed by a user.

In the present invention, a mobile app 6 includes program code 15 stored in a non-transitory storage device (referred to as memory 14) of a mobile computing device 8 that, when executed by the processor 12 performs the steps of receiving a physical activity challenge 20 that includes a timing parameter 22 (also called a timing element) and a reward parameter 24 (also referred to as a reward element), receives activity data from an activity sensor 18 (which may be the camera of the phone) associated with the mobile computing device 8 that is indicative of a human user associated with the app 6 seeking to complete the physical activity challenge 20. Uniquely, the app 6 includes programming instructions that enable the user to wager/bet on his or her own ability to complete the received the physical activity challenge and, in some embodiments, to complete the challenge faster than any other user can complete the same physical activity challenge. These method steps will now be described in more detail.

There are at least two ways that said physical activity challenge 20 may be received by the app 6. In one embodiment, the physical activity challenge 20 is predetermined by the makers of the app 6 and embedded in the software itself. At a predetermined date and time or at the request of a user operating the mobile app, the physical activity challenge 20 may be accessed and published, i.e., displayed on a display 13 screen associated with the mobile computing device 8 for viewing by a human user of the mobile computing device 8 and app 6. In an embodiment, the user associated with the app 6 utilizes human effort to complete the physical activity challenge 20 and records evidence of completion using an activity sensor 18 associated with the mobile computing device 8. The activity sensor 18 referred to herein may be the camera feature of the smart phone which may be capable of and configured to take still photographs or a video for generating activity data indicative of completion or attempted completion of the received physical activity challenge 20.

In an important aspect, the received physical activity challenge 20 may include a time element 22 and a reward element 24. The reward element 24 will be released or given to the user of the app 6 if the condition of completion or the combination of completion according to the time element is met. Further, the time element 22 may be a completion time requirement 22a or may include an elapsed time calculator 22b. It will be understood that said completion time requirement 22a represents a fixed quantity of minutes or seconds in which the physical activity challenge 20 must be completed. Specifically, this may require the user, using the app 6, to record and enter or attach the video evidence indicative of completion of the physical activity challenge 20. For example, if the physical activity talents 20 is shooting and making 10 three-pointers on a basketball goal, then the user may attach a video of himself thinking 10 three-pointers and then uploading that so long as he completed them in the required amount of time. The app 6 includes instructions capable of time stamping attachment of the video or pictorial evidence. In the other instance, the app 6 may include instructions that, in cooperation with the elapsed time calculator 22b, will keep track of an amount of time it takes the user to complete the physical activity challenge 20 and attach the video record thereof to the app 6.

There is an element that is critical to the present invention. Namely, a user, using the app 6, may input and submit a wager/bet that is indicative of or associated with completion of the physical activity challenge 20 and is, in one embodiment, associated with completing the physical activity challenge 20 in a personal best amount of time or, in another embodiment, faster than any other competitor who may also submit a completion elapsed time. This wager/bet data may be input by a user using an input device such as a keypad or numeric keys. In the embodiment described above, the mobile app 6 includes instructions capable of evaluating the generated activity data submitted by the app 6, including data regarding a completion time and/or elapsed time, so as to determine if the user associated with the app 6 has, in fact, completed the challenge and earned the specified reward. In a critical step, if the reward is earned as described above, the reward is released and given to the app 6 along with the amount of the wager/bet or, in the case of a percentage wager, the reward multiplied by the wager/bet.

For instance, the physical challenge may include the associated user being required to do 15 chin-ups. Using the camera (activity sensor 18), the user may make a video record of himself doing the 15 chin-ups and this generated data may be captured by or attached to the app 6. As stated above, the app 6 includes program code 15 capable of evaluating the submitted generated data so as to determine completion. The app also includes program code 15 capable of receiving the wager data entered by a user.

The other way that the physical activity challenge 20 may be received by the mobile computing device 8 that is running the mobile app 6 is receiving it from third-party entity 19 that is remote from the app 6 such that the challenge is accessed by the app 6 accessing the third-party entity 19 or, the third-party entity 19 (also referred to as the app administrator 18) delivering the physical activity challenge 20 to the mobile app 6 at a predetermined date and time and in real time. It is understood that each of a plurality of users of the mobile app 6 may be required to log in to the third-party entity 19 as is common when accessing certain websites. The third-party entity 19 may also include a microprocessor and program instructions capable of receiving data, processing received data according to said program instructions, transferring predetermined physical activity challenges to registered users via the Internet 11, and determining which submitted data is indicative of completing a respective challenge, and then calculating a respective reward according to a respective wager. More particularly, the third-party entity 19 may send the same physical activity challenge 20 to a plurality of registered apps 6 running on a plurality of mobile computing devices 8, respectively, each running in the manner described above in detail. The embodiment of the system 10 described in this paragraph is illustrated in FIG. ______ and described in detail below.

The mobile application 6 includes program code 15 that, when executed by the processor 12, operates a process 100 and methodology shown in FIG. ______. First, the processor 12, executing program instructions, determines if data associated with or indicative of the physical activity challenge 20 has been received, as indicated at block 102 and, if so, the process continues to blocks 102a and 102b where the time and reward elements are stored to to respective data structures 16. But, if not, the process 100 simply loops to itself and continues waiting and checking for data associated with the challenge to be received. As indicated previously, data regarding the physical challenge may be included or embedded within the program code 15 itself or via the internet 11 or from communication with the third-party entity 19 via the internet 11 and through the interface of the app 6.

Once the challenge has been received, program control is directed to the wagering aspect. As shown at block 104, the processor 12 solicits the associated user via the app 6 to enter a numerical value representing a quantity of money that the associated user desires to wager/bet on his own ability to complete the challenge and to completed faster than any other user who is also competing to complete the same challenge. In an embodiment, the physical activity challenge 20 may be delivered at a predetermined date and time such that a competition is undertaken in real time and simultaneously amongst a plurality of registrants.

Once the wager is entered, the process 100 proceeds to block 106 where completion of the challenge may be proven, preferably by the associated user recording a video of himself completing the challenge using and activity sensor 18 of the mobile computing device 8 associated with the mobile app 6. In other words, the mobile app 6 may be configured to enable a video or still shots, as the case may be, to be attached or uploaded. Preferably, the mobile app 6 is programmed to keep track of the overall completion time requirement, shown at block 106a as well as a total elapsed time for completion shown at block 106b. In other words, the mobile app 6 is able to determine if the challenge has been completed in the prescribed time element (which was stored in a respective memory location at the time the physical activity challenge was received) as well as determining how fast each registrant completed it.

The process 100 then proceeds to block 108 where the processor 12 determines if the physical activity challenge 20 was, in fact, completed within the required time parameter and is so, the process 100 proceeds to block 110. If however, the processor 12 determines that the physical activity challenge 20 was not completed within the required time, the process 100 simply ends and this respective mobile app 6 receives no reward. At block 110, a complete set of competition data generated by the mobile app 6, including completion data, time data, and wager data is transmitted to the third-party entity 19 (i.e., to the administrator) for a determination whether the respective mobile app 6 (and associated user) is the winner.

The system 10 also includes a process 200 by which the third-party entity 19 (i.e., the app administrator) operates. It is understood that the third-party entity 19 may include a computing device having a processor for executing program code. As such, the app administrator 19 determines and assigns the physical activity challenge to the mobile app 6 described above as well as to identical mobile apps associated with a plurality of registrants of the system, as shown at block 202. The predetermined physical activity challenge determined at block 202 includes a predetermined time element and predetermined reward for the winner, as shown in blocks 202a and 202b, respectively. It is understood that the elements of a challenge and its respective parameters may be input into the computing device with a keyboard, keypad, or other standard input means. Once the challenge has been issued to all registrants, the process 200 proceeds to block 204 where its processor begins receiving generated competition data from each registrant (including the specific mobile app 6 described in detail above. The process 200 proceeds to step 206 where the processor determines if generated data from all participating registrants has been received or for a predetermined amount of time, after which control is passed to block 208

. At step 208, the processor associated with the app administrator, determines which of registrants (i.e., which mobile apps) fully completed the challenge. It is understood that this step may cycle repeatedly until all generated data and, specifically, respective completion data, has been evaluated so as to filter the submissions. Control is then passed to block 210, where the processor associated with the app administrator determines which of the remaining submitters completed the physical activity challenge 20 in the shortest elapsed time. At this point, a winner has been determined and the process 200 proceeds to block 212 where the predetermined reward amount is augmented or increased by the amount of the wager/bet data associated with the winning mobile app 6. Process 200 proceeds to block 214 where the winning mobile app is contacted, via the Internet, and payment arrangements may be made.

. Accordingly, a unique online gaming system and method is devised that combines the elements of completing a physical activity challenge in the shortest amount of time and as recorded on the respective user's cell phone and which enables a user to wager/bet on his own ability to complete the challenge faster than all other competitors on the same challenge.

It is understood that while certain forms of this invention have been illustrated and described, it is not limited thereto except insofar as such limitations are included in the following claims and allowable functional equivalents thereof.

1. A computer implemented system for completing and wagering on a physical challenge includes a processor for executing program code and a non-transitory computer-readable storage medium containing program code executable by an electronic device to perform the steps of:
receiving a physical activity challenge including a timing parameter and a reward parameter;
generating activity data using an activity sensor associated with the electronic device;
receiving wager data associated with said reward parameter to be received before said physical activity challenge has been completed;
determining, based on said generated activity data, whether said received physical activity challenge has been completed and, if so, determining if said completion occurred pursuant to said timing parameter and, if so, generating reward data;
receiving and displaying said generated reward data.

2. The system as in claim 1, wherein said physical activity challenge is embedded in and accessed via the program code.

3. The system as in claim 1, wherein said physical activity challenge is received from a third-party transmission entity remote from the processor.

4. The system as in claim 1, wherein the processor and the non-transitory computer-readable storage medium are situated in the electronic device.

5. The system as in claim 4, wherein the electronic device is one of a smart phone, tablet, laptop computer, desktop computer, or digital smart watch.

6. The system as in claim 3, wherein said timing parameter includes a fixed completion time requirement or an elapsed time calculator.

7. The system as in claim 6, wherein said activity sensor is a camera.

8. The system as in claim 7, further comprising:
transmitting said generated activity data and said wagering data to said third-party transmission entity, said third-party transmission entity determining if said generated data is indicative that said received physical activity challenge has been completed; an
receiving a reward from said third-party transmission entity equal to said reward parameter increased by a factor indicated by said wagering data if said received physical activity challenge has been completed according to said timing parameter and said generated data.

9. The system as in claim 7, further comprising:
transmitting said generated activity data and wagering data to said third-party transmission entity, said third-party transmission entity determining if said generated data is indicative that said received physical activity challenge has been completed and if said elapsed time calculator is indicative of a fastest completion time in comparison to comparable activity data and comparable wagering data transmitted to said third-party transmission entity from at least another non-transitory computer-readable storage medium containing the program code; and
receiving a reward from the third-party transmission entity equal to said reward parameter increased by said wagering data if said received physical activity challenge has been completed according to said timing parameter and said generated data.

10. The system as in claim 9, wherein said physical activity challenge is received in real time and at a predetermined date and time.

11. The system as in claim 9, wherein said physical activity challenge is transmitted by said third-party transmission entity in real time.

12. The system as in claim 1, wherein said wagering data is indicative of a user associated with the electronic device betting on his ability to complete said received physical activity challenge and having a respective elapsed time calculator, respectively, smaller than a an analogous elapsed time calculator associated with said at least another non-transitory computer-readable storage medium.

13. A computer implemented system for completing and wagering on a physical challenge includes a processor for executing program code and a non-transitory computer-readable storage medium containing program code executable by an electronic device to perform the steps of:
receiving a physical activity challenge including a timing parameter and a reward parameter;
displaying said received physical activity challenge on a display associated with said electronic device;
wherein said physical activity challenge is received from a third-party transmission entity that is remote from the processor;
generating activity data associated with completing said received physical activity challenge using an activity sensor associated with the electronic device, said generated activity data including completion time data and elapsed time data;
receiving wager data associated with said reward parameter, said wager data being input via an input device associated with the electronic device and input before said physical activity challenge has been completed;
transmitting said generated activity data, said completion data, said elapsed time data, and said wager data to the third-party transmission entity;
receiving reward data from said third-party transmission entity and displaying said received reward data on the display associated with the electronic device, said received reward data being indicative that said third-party transmission entity has determined, based on respective transmitted data, that said received physical activity challenge has been completed and that said elapsed time data is indicative of a fastest completion time in comparison to comparable activity data transmitted to said third-party transmission entity from at least another non-transitory computer-readable storage medium containing the program code.

14. The system as in claim 13, wherein the electronic device is one of a smart phone, tablet, laptop computer, desktop computer, or digital smart watch.

15. The system as in claim 13, wherein said activity sensor is a single photograph camera or a video camera.

16. The system as in claim 13, wherein said third-party transmission entity includes a processor and program code executed thereby for determining if said generated data is indicative that said received physical activity challenge has been completed and if said elapsed time calculator is indicative of a fastest completion time in comparison to comparable activity data and comparable wagering data transmitted to said third-party transmission entity from at least another non-transitory computer-readable storage medium containing the program code.

17. The system as in claim 13, wherein said physical activity challenge is received in real time and at a predetermined date and time.

18. The system as in claim 13, wherein said physical activity challenge is transmitted by said third-party transmission entity in real time.

19. The system as in claim 13, wherein said wagering data is indicative of a user associated with the electronic device betting on his ability to complete said received physical activity challenge and having a respective elapsed time calculator, respectively, smaller than a an analogous elapsed time calculator associated with said at least another non-transitory computer-readable storage medium.

20. A method for completing and wagering on a physical challenge, comprising:
providing a computing device programmed to execute program code for:
receiving a physical activity challenge including a timing parameter and a reward parameter;
wherein said physical activity challenge is received from a third-party transmission entity that is remote from the processor;
generating activity data associated with completing said received physical activity challenge using an activity sensor associated with the computing device, said generated activity data including completion time data and elapsed time data;
receiving wager data associated with said reward parameter, said wager data being input via an input device associated with the electronic device and input before said physical activity challenge has been completed;
transmitting said generated activity data, said completion data, said elapsed time data, and said wager data to the third-party transmission entity;
receiving reward data from said third-party transmission entity, said received reward data being indicative that said third-party transmission entity has determined, based on respective transmitted data, that said received physical activity challenge has been completed and that said elapsed time data is indicative of a fastest completion time in comparison to comparable activity data transmitted to said third-party transmission entity from at least another non-transitory computer-readable storage medium containing the program code; and
said third-party transmission entity determining, based on said generated activity data, whether said received physical activity challenge has been completed and, if so, determining if said completion occurred pursuant to said timing parameter and, if so, generating reward data

21. The method as in claim 20, further comprising:
displaying said received physical activity challenge on a display associated with said electronic device;
displaying said received reward data on the display associated with said computing device.

22. The system as in claim 20, wherein the computing device is one of a smart phone, tablet, laptop computer, desktop computer, or digital smart watch.

23. The system as in claim 20, wherein said activity sensor is a single photograph camera or a video camera.

24. The system as in claim 20, wherein said physical activity challenge is received in real time and at a predetermined date and time.

25. The system as in claim 20, wherein said physical activity challenge is transmitted by said third-party transmission entity in real time.
